(19) United States
(12) Patent Application Publication
(10) Pub. No.: US 2008/0232564 A1
(43) Pub. Date: Sep. 25, 2008

(54) Call hunt and ringback on the phone through messenger

(75) Inventor: Sanjay Kumar Gupta, Sunnyvale, CA (US)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc.

(21) Appl. No.: 11/725,789

(22) Filed: Mar. 19, 2007

(51) Int. Cl. H04M 11/00

(52) U.S. Cl. 379/93.09

(57) ABSTRACT

Techniques that enable a user to make VOIP phone calls using a traditional telephone by directing a communications module to connect the caller to another user are provided. The caller first dials a DID and identifies a receiver to be reached. Once the caller has identified the receiver, the caller may hang up the phone and wait until the communications module contacts the caller once the receiver has been connected. The communication module hunts the receiver using the receiver's multiple contact information by calling each of the receiver's contact numbers. Once the receiver answers one of the calls, the communications module detects that the receiver has been connected and then contacts the caller. Finally, once the caller answers the telephone, the caller and the receiver are connected and a communication may commence.

### FIELD OF THE INVENTION

The present invention relates to making calls on a phone using voice over internet protocol, more specifically for a person to use a traditional telephone to make calls to others.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Voice over Internet Protocol, or VOIP, is the routing of phone calls over the Internet or any other IP-based network. When a phone call is made using VOIP, the caller speaks into a microphone in a computer where his voice is converted into IP packets that are then routed over the network. When the IP packets reach the receiver, the IP packets are converted from IP packets into sound and the caller's voice is heard over the speaker in the receiver's computer. The same method occurs in the reverse direction when the receiver speaks to the caller.

There are many advantages to using VOIP. Because the cost for carriers to route Internet packets over the Internet is extremely low, making computer-to-computer calls is very inexpensive or even free. In addition, the mobility of the user may be greatly enhanced. For example, if a user has a communications application on a laptop computer to make VOIP calls, the user may freely roam with the laptop computer and make or receive calls in any location where an Internet connection is present. For example, the user might be located either in Europe or just down the street, but to the other person on the line, the user's location would not appear any different.

However, limitations exist with using VOIP with computer-to-computer calling. First, both the caller and receiver user must own and be currently using their computers. The cost of the equipment becomes a factor and not being able to roam away from their computer is inconvenient. Second, in many locales, uninterrupted power and access to the Internet is limited. The connection to the Internet, or quality of service, is a concern because the reliability of the connection directly affects the quality of the VOIP call. For example, if IP packets were lost or delayed at any point in the network between VOIP users, then a momentary drop-out of voice results.

VOIP has progressed from being exclusively able to make computer-to-computer calls to making telephone connections using traditional telephones. A media gateway acts as a translation unit between disparate telecommunications networks. Media gateways enable multimedia communications across networks over multiple transport protocols including Internet Protocol. For example, when a caller wishes to communicate with another user, the caller's computer first connects to the Internet. From the Internet, the traditional telephone network is interfaced via the media gateway. Since the media gateway handles the translation from IP packets to the traditional telephone network, the caller and the receiver would speak as though this was a direct connection. The ability to call traditional phones from the Internet greatly eases the burden on the receiver because there is no longer a requirement to own a computer, and the receiver need not sit at their computer awaiting for the connection from the caller.

In addition, VOIP phone providers have provided methods in which callers on traditional telephone networks may call an individual on their computer using VOIP. Traditional telephone networks use a standard called “public switched telephone network” (PSTN). PSTN is a network of the world's public circuit-switched telephone networks. There are two types of PSTN to VOIP services: direct inward dialing (DID) and access numbers. DID numbers from the PSTN network are obtained by the administrators of the VOIP network, and assigned to a gateway in the VOIP network. A gateway is a network node equipped for interfacing with another network that uses different protocols. The media gateway routes calls incoming from the PSTN across the IP network to the appropriate VOIP user. Access numbers require the caller to input the extension number of the VOIP user after dialing into an access number made available by the provider. Access numbers are usually charged as a local call to the caller and free to the VOIP user while DID usually has a monthly fee.

Special phones have also been developed to be used in a VOIP network. The special phones plug directly into a broadband connection and operate largely like a traditional telephone. These special phones have features that mimic many of the characteristics of traditional phones with the same method of dialing a phone number and the presence of a dial tone. However, these special phones still require a separate purchase and are not compatible with the existing traditional telephone network.

However, making computer-to-telephone calls is a frustrating experience when attempts to connect to the receiver are made repeatedly but left unanswered or when the line is busy. The caller must still use his or her computer and be actively making the calls in the hope that the other party will answer. The caller may first attempt to connect to the other party's home phone, then the other party's work phone and finally the other party's mobile phone. Thus, there is a clear need for techniques to improve the computer-to-telephone calling experience.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram of an embodiment in which a caller contacts and connects to a receiver;

FIGS. 2A and 2B are diagrams of an embodiment that show the steps when a caller contacts and connects to a receiver;

FIG. 3 is an illustration of the steps in the call flow according to an embodiment of the invention; and

FIG. 4 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

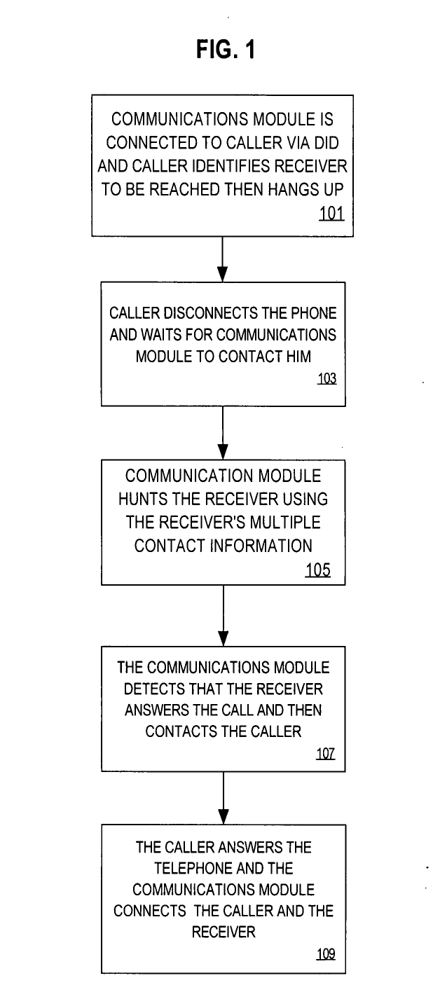

Techniques are described that enable a caller to make VOIP phone calls using a traditional telephone by directing a communications module to connect the caller to another user (the “receiver”). A general overview of the technique is shown in FIG. 1. The caller first dials a DID and identifies the user to be reached in block 101. Once the caller has identified the receiver, the caller may hang up the phone and wait until the communications module contacts the caller once the receiver has been connected in block 103. The communication module hunts the receiver using the receiver's multiple contact information by calling each of the receiver's contact numbers in block 105. Once the receiver answers one of the calls, the communications module detects that the receiver has been connected and then calls the caller in block 107. Finally, once the caller answers the telephone, the caller and the receiver are connected and a communication may commence in block 109.

### Caller Connects to Communications Module

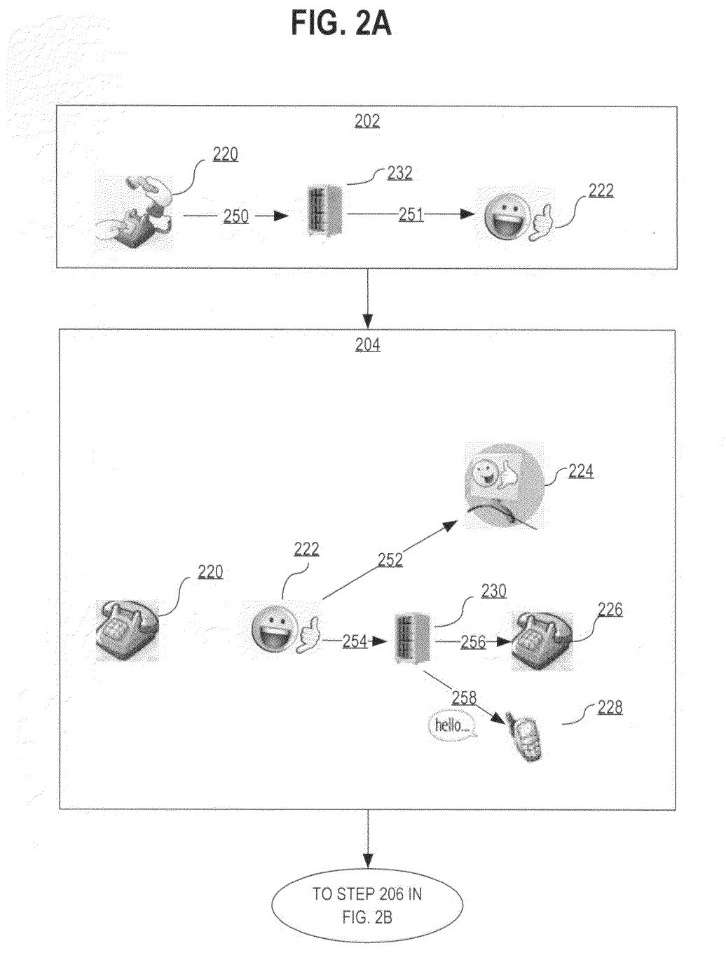

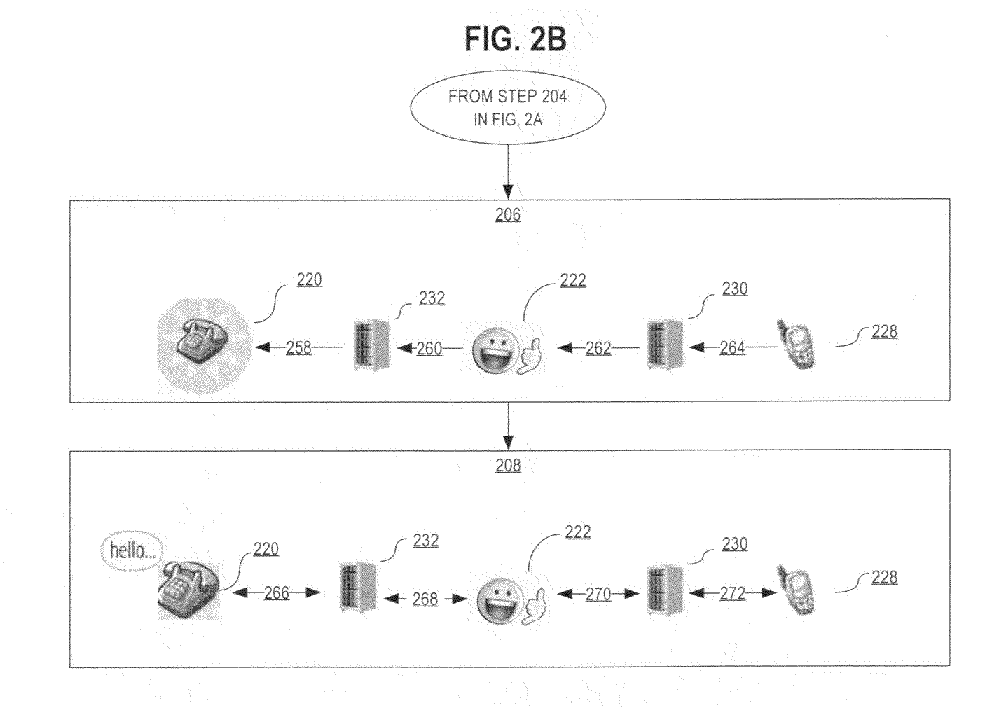

An illustration of an embodiment of the invention is shown in FIG. 2A. In an embodiment of the invention, a user makes a call using his traditional telephone 220 to a DID in order to access his VOIP account as shown in step 202. As used herein, a traditional telephone refers to an ordinary land-line based telephone over PSTN or may also refer to mobile devices using cellular technology capable of performing communications between users. As mentioned previously, VOIP calls are possible using a traditional telephone because media gateways act as a translation unit between PTSN networks (through which the traditional phone connects) and IP-based networks (through which VOIP operates). The call connects first to a media gateway 232 and then to a communications module 222. The connection to the media gateway 232 is connection 250 and the connection from the media gateway 232 to the communications module 222 is connection 251. The communications module 222 may be part of a communications program on the user's computer. Communications programs are capable of performing, in addition to VOIP calls, other communicating applications such as, but not limited to, video conferencing or online instant text messaging. An example of such a communications program is Yahoo! Messenger.

In another embodiment, the communications module resides alone on the user's computer. By remaining apart from a larger communications program, the communications module uses less of a computer's resources while still allowing the user to make VOIP calls. In another embodiment, the communications module may reside on another user's computer so that the communications module is shared with more than one user. Sharing the communications module has the advantage of not maintaining a separate computer for each user. In another embodiment, the communications module may reside on a central server and not on any user's individual computer.

### Authentication of Caller

In an embodiment of the invention, once the caller connects to the communications module via regular telephone, the communications module authenticates the caller. Authentication is the process that validates that the user who called an account is the authorized user of the account. Authentication may be performed automatically without any additional prompting by the communications module. The communications program identifies the phone number of the originating call and compares the originating phone number to a list of phone numbers, referenced herein as the authentication list, maintained by the communications module. If the originating phone number matches any phone number on the authentication list, then the user is automatically authenticated. If the originating phone number does not match any phone number on the authentication list, then the user is authenticated via voice prompts. For example, the user might only call the communications module from the user's home telephone or cellular phone. In this circumstance, the user submits, at a prior time, his home telephone number and cellular phone number to the communications module to be added to the authentication list. If the caller connects to the communications module from his home or cellular phone, then the communications module authenticates the user. If the user connects to the communications module using his work phone that is not on the authentication list, then the communications module authenticates using voice prompts.

In another embodiment, the communications module may authenticate the caller by using interactive voice response or “IVR”. When the user is connected to the communications module on a telephone number not listed on the authentication list, the communications module prompts the user to enter a security code. If the user enters a correct security code, then the user is granted access. If the authentication fails, then the communications module plays a voice prompt to re-enter the authentication information. In an embodiment, the maximum number of authentication attempts is preset by the communications module or set by the user. If the number of authentication attempts exceeds the maximum number of attempts, the call is disconnected. In another embodiment of the invention, the entire authentication process may be discontinued by the user and all calls to the communications module are accepted.

### Identifying the Receiver

In an embodiment, the communications module uses IVR to prompt the user to enter an identification code to connect to a receiver. The identification code may be, but is not limited to, a telephone number, a name, or a short sequence of numbers. The short sequence of numbers, referenced herein as speed dial numbers, may be implemented as a single or multiple digit number and may be assigned by the communications module or previously identified by the user. The caller identifies the receiver using the speed dial number. If the identification code is not valid, or unrecognized by the communications module, the communications module prompts the user to re-enter the identification code. In another embodiment, the speed dial number may identify only a single contact number of the receiver wherein each contact number of the receiver has a different speed dial number. Once the speed dial number is entered by the caller, the caller hangs up the telephone and awaits the communications module to contact the user once the call is connected.

The communications module determines the referenced receiver in the identification code and finds the receiver's connection information. The receiver's connection information may include, but is not limited to, the receiver's home phone number, cellular phone number or identification name to connect to the receiver via their computer.

### Connecting to the Receiver

The communications module attempts to reach each of these numbers in parallel or in sequence as shown in step 204 of FIG. 2A. Attempts made in parallel try all connection numbers at the same time. Attempts made in sequence try each connection number separately in turn. If the calls are made in sequence, then the contact information has a priority list of the contact numbers. The priority list directs the communications module 222 in which order to attempt each contact number. For example, calls might be given a higher priority based on the cost of the call. Thus, in this circumstance, calls made to another computer 224 would be given the highest priority since VOIP calls represent the cheapest method of connection. No media gateway is required since connecting to the receiver's computer 224 uses a VOIP connection 252. Should a call be made to the receiver's home phone 226 or cellular phone 228, the connection would be via VOIP to the PTSN of the receiver's home phone or the PTSN of the receiver's cellular phone. A media gateway 230 translates the connection from the VOIP connection 254 of the communications module to the PTSN of the receiver's home phone (connection 256) or to the PTSN of the receiver's cellular phone (connection 258). Other criteria, such as the expected clarity of the call, may be used to prioritize the contact information. If the call is made internationally, then the clearest calls would be to the receiver's land line, and so the land line would have the highest priority. In an embodiment, the user sets the priority list for each receiver. In another embodiment, the user sets general priorities, such as by cheapest connection method, and the communications module prioritizes each contact number.

In an embodiment of the invention, the communications module attempts to connect using the contact method with the highest priority. If the call does not connect due to either the receiver not answering or a busy signal, then the communications module cancels or time-outs the call. The communications module then calls the next contact number on the priority list for the receiver. In another embodiment, a set number of rings is detected by the communications module before the call times out. Stopping the connection process after a set number of rings minimizes toll charges by avoiding unwanted connections to voice mail and answering machines. Each contact number for the receiver is attempted until either all attempts have timed-out, have been canceled, or the call is answered by the receiver. If the communications module attempts all of the contact numbers without success at connecting with the receiver, the communications module delays for a set amount of time and attempts to connect again. In another embodiment, the communications module immediately attempts to connect to the highest contact number on the priority list and repeats the process.

In another embodiment, the calls are made in parallel to all of the contact numbers at the same time. There is a higher likelihood that the receiver answers the call because multiple locations are tried at once. One limitation to connecting in parallel is that priority cannot be taken into account. For example, the caller might only wish to connect the call to the receiver's computer and have a VOIP call in order to minimize costs. In this circumstance, the parallel method would not accomplish the cost savings as priority is not taken into account. In another embodiment, modified parallel calling is performed where only certain contact numbers are tried in parallel. If the user wishes to minimize costs, perhaps by limiting the calls to only VOIP calls, the communications module attempts to contact numbers that connect by VOIP.

### Connecting the Caller

In an embodiment of the invention, once the receiver 228 answers at a contact number, the communications module 222 detects the connection and contacts the caller 220 as shown in step 206 of FIG. 2B which is a continuation of the steps from FIG. 2A. In the example, the connection is made to the receiver's cellular phone 228. Because the connection is made to a cellular phone, the connection from the communications module to the receiver's cellular phone must be translated by a media gateway 230. Thus, the receiver's response is first to the media gateway in connection 264 and then from the media gateway to the communications module in connection 262. The communication module 222 calls the receiver either at the originating telephone number 220 or at another phone number identified by the caller. The call to the caller must once again go through a media gateway 232. When the communications module 222, contacts the caller 220, a connection 260 is made from the communications module to the media gateway, and then a connection 258 from the media gateway to the caller's telephone.

Once the caller answers the call, the communication module connects the caller to the receiver and the call commences. In this circumstance, a media gateway connects the VOIP connection to the PSTN of the caller's telephone as shown in step 208. The receiver is connected to the receiver via the communications module 222 and a media gateway 232 at the caller's end and a media gateway 230 at the receiver's end. The caller has a connection 266 from the caller's telephone 220 to the media gateway 232 and then from the media gateway 232 to the communications module 222 in connection 268. The communication module 222 is connected to the receiver 228 via a media gateway 230 with a connection 270 from the communications module 222 to the media gateway 230, and then a connection 272 from the media gateway 230 to the receiver's cell phone 228.

In an embodiment, the communications module connects the caller to the receiver directly. The communications module is bypassed in the connection between the caller and the receiver. This allows the caller to power down and remove the computer where the communications module resides because the communications module is no longer required. In another embodiment, the communication module remains as a link between the caller and the receiver. When the caller or receiver hangs up their connection, the communications module detects the end of the connection and disconnects the call.

### Overview of Call Flow

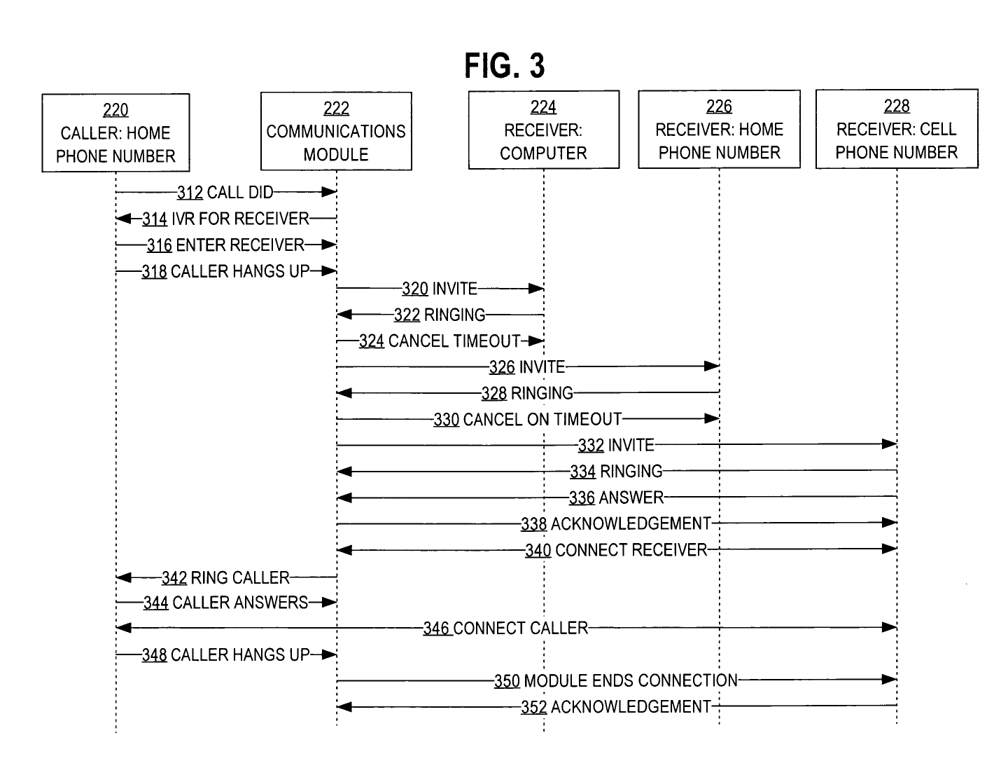

An illustration of the steps in the call flow according to an embodiment of the invention is shown in FIG. 3. In order to simplify the illustration, media gateways that perform the translations from the VOIP network to the PTSN network are not shown.

The caller 220, from a home phone number, calls a DID to connect to the communications module 222 as shown in step 312. Once connected, the communications module 222, uses interactive voice recognition in order to prompt the caller for the receiver to be reached in step 314. The caller sends the receiver identification to the communications module 222 in step 316 and then hangs up in step 318 and waits for the receiver to connect.

The communications module 222, after receiving identification of the receiver, invites the receiver by attempting to connect to the receiver's computer 224, the receiver's home phone number 226, and the receiver's cell phone 228. At step 320, the communications module 222, invites the receiver via the receiver's computer 224. Step 322 shows that the computer 224 acknowledges the attempt by ringing. At step 324, the attempt is canceled because the call was not answered before a specified time.

In step 326, the communications module 222, attempts to connect to the receiver at the receiver's home phone 226. The home telephone 226 acknowledges the attempt by ringing in step 328. Unfortunately, no answer is made before a specified time and the attempt is canceled in step 330.

The communications module 222 next attempts the receiver's cell phone number in step 332. The cell phone 228 rings based on the attempt on step 334. The receiver answers the cell phone in step 336. In response to the cell phone 228 being answered, the communications module 222 sends an acknowledgement that the cell phone 228 was answered in step 338. The receiver is then connected to the communications module 222 in step 340.

The communications module 222 then contacts the caller 220 that the receiver is connected in step 342. In step 344, the caller answers the call from the communications module 222 and is connected with the receiver in step 346. Once the conversation is ended and the caller wishes to end the call, the caller hangs up the caller's home telephone 220 in step 348. The communications module 222 then ends the connection with the receiver 228 in step 350 and the receiver acknowledges the end of the connection in step 352.

### Hardware Overview

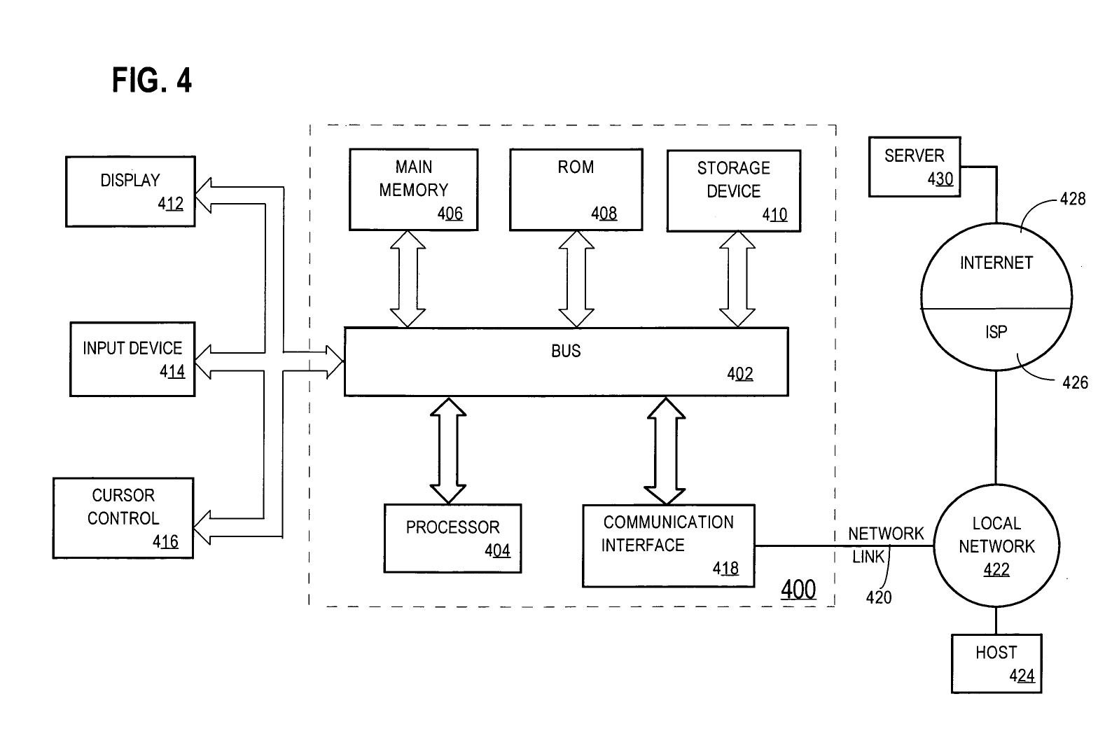

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave. In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method, comprising:
receiving a first request from a first user;
upon receiving the first request from the first user, sending a second request to the first user;
receiving in response to the second request, an answer that identifies a second user;
determining one or more contacts that are associated with the second user;
based on the one or more contacts, inviting the second user to communicate with the first user;
in response to the second user accepting the invitation, sending a third request to the first user;
in response to the first user accepting the third request, connecting the first user with the second user.

2. The method of claim 1, wherein the first request is from a traditional telephone.

3. The method of claim 1, wherein the first request is a DID call.

4. The method of claim 1, wherein upon receiving the first request from the first user further comprises authenticating the first user.

5. The method of claim 3, wherein authenticating the first user is performed automatically.

6. The method of claim 3, wherein authenticating the first user is performed by using interactive voice prompts.

7. The method of claim 1, wherein inviting the second user to communicate with the first user further comprises connecting to the one or more contacts associated with the second user in parallel.

8. The method of claim 1, wherein inviting the second user to communicate with the first user further comprises connecting to the one or more contacts associated with the second user in sequence.

9. The method of claim 8, wherein connecting to the one or more contacts associated with the second user in sequence further comprises maintaining a priority list of which contact to attempt first.

10. The method of claim 1, wherein the first request is made to a communications module that is part of a larger communications program.

11. The method of claim 1, wherein the first request is made to a stand-alone communications module that is part of a larger communications program.

12. The method of claim 10, wherein the communications module is located on a computer of the first user.

13. The method of claim 10, wherein the communications module is located on a computer of a third user.

14. The method of claim 10, wherein the communications module is located on a central server.

15. The method of claim 10, wherein connecting the first user with the second user is through a voice over IP network.

16. A machine-readable storage medium carrying one or more sequences of instructions which, when executed by one or more processors, causes the one or more processors to perform the method recited in claim 1.

17. A machine-readable storage medium carrying one or more sequences of instructions which, when executed by one or more processors, causes the one or more processors to perform the method recited in claim 2.

18. A machine-readable storage medium carrying one or more sequences of instructions which, when executed by one or more processors, causes the one or more processors to perform the method recited in claim 3.

19. A machine-readable storage medium carrying one or more sequences of instructions which, when executed by one or more processors, causes the one or more processors to perform the method recited in claim 4.

20. A machine-readable storage medium carrying one or more sequences of instructions which, when executed by one or more processors, causes the one or more processors to perform the method recited in claim 5.

21. A machine-readable storage medium carrying one or more sequences of instructions which, when executed by one or more processors, causes the one or more processors to perform the method recited in claim 6.

22. A machine-readable storage medium carrying one or more sequences of instructions which, when executed by one or more processors, causes the one or more processors to perform the method recited in claim 7.

23. A machine-readable storage medium carrying one or more sequences of instructions which, when executed by one or more processors, causes the one or more processors to perform the method recited in claim 8.

24. A machine-readable storage medium carrying one or more sequences of instructions which, when executed by one or more processors, causes the one or more processors to perform the method recited in claim 9.

25. A machine-readable storage medium carrying one or more sequences of instructions which, when executed by one or more processors, causes the one or more processors to perform the method recited in claim 10.

26. A machine-readable storage medium carrying one or more sequences of instructions which, when executed by one or more processors, causes the one or more processors to perform the method recited in claim 11.

27. A machine-readable storage medium carrying one or more sequences of instructions which, when executed by one or more processors, causes the one or more processors to perform the method recited in claim 12.

28. A machine-readable storage medium carrying one or more sequences of instructions which, when executed by one or more processors, causes the one or more processors to perform the method recited in claim 13.

29. A machine-readable storage medium carrying one or more sequences of instructions which, when executed by one or more processors, causes the one or more processors to perform the method recited in claim 14.

30. A machine-readable storage medium carrying one or more sequences of instructions which, when executed by one or more processors, causes the one or more processors to perform the method recited in claim 15.
